(19) United States
(12) Patent Application Publication
(10) Pub. No.: US 2009/0033039 A1
(43) Pub. Date: Feb. 5, 2009

(54) Gasket with asymmetric bead arrangement

(75) Inventors: Scott M. Anderson, Canton, MI (US); Yingjie Kong, East Lyme, CT (US); Martin Novil, Northville, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/167,975

(22) Filed: Jun. 28, 2005

(51) Int. Cl. F16J 15/08

(52) U.S. Cl. 277/595

(57) ABSTRACT

An asymmetric bead formed in a gasket is provided. The gasket defines a plane. The bead includes a first half emboss portion positioned at a first angle to the plane of the gasket. A bead top portion is positioned parallel to the plane of the gasket and is connected to the first half emboss portion. A second half emboss portion is positioned at a second angle to the plane of the gasket and is connected to the bead top portion. The first angle is greater than the second angle so that the length of the first half emboss portion is shorter than the second half emboss portion and therefore, has a smaller surface area being acted on by a higher pressure fluid on the first half emboss portion so that the forces acting on the first and second half emboss portions are equalized.

### FIELD OF THE INVENTION

The present invention relates to gaskets, and more particularly to gaskets having an asymmetric bead arrangement.

### BACKGROUND AND SUMMARY OF THE INVENTION

Gaskets are used in a wide variety of applications to form a seal between two matched parts. Gaskets are also utilized for separating two mediums. For example, in an engine, a gasket may provide a seal between an oil cavity and a coolant cavity. Often, the pressures experienced in one of the cavities can greatly exceed the pressures exerted in the other cavity.

Accordingly, the present invention provides the art with a gasket having an asymmetric bead that allows for a gasket to properly fit between two matching parts while accounting for variations in the compressive forces on the gasket. The gasket defines a plane. The asymmetric bead includes a first embossment half portion positioned at a first angle to the plane of the gasket. A bead top portion is positioned parallel to the plane of the gasket and is connected to the first portion. A second embossment half portion is positioned at a second angle to the plane of the gasket and is connected to the second portion. The first angle is greater than the second angle so that the compressive force on the first embossment half portion is greater than on the second embossment half portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top view of a gasket having an asymmetric bead arrangement constructed according to the principles of the present invention; and

FIG. 2 is a cross-sectional view of the gasket having the asymmetric bead arrangement of the present invention viewed in the direction of arrow 2-2 in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

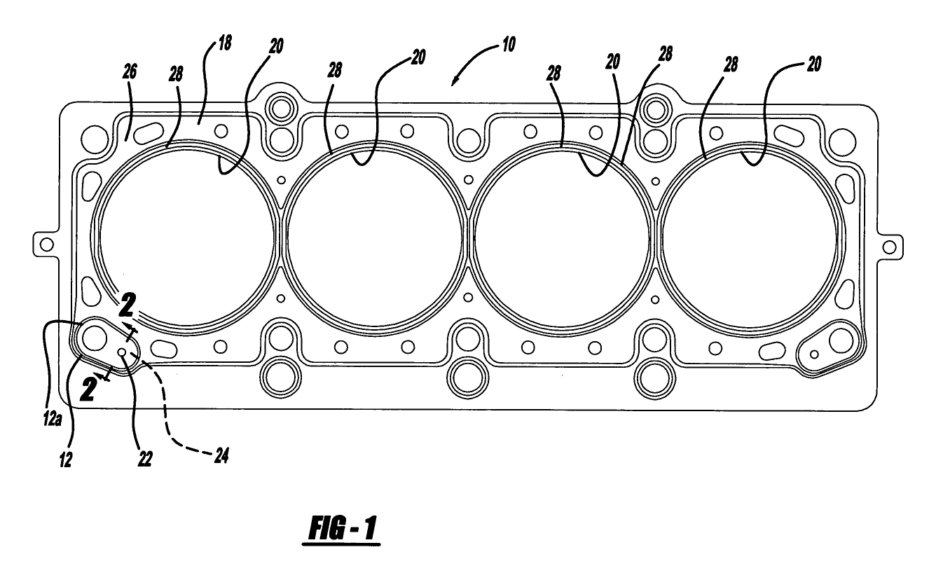

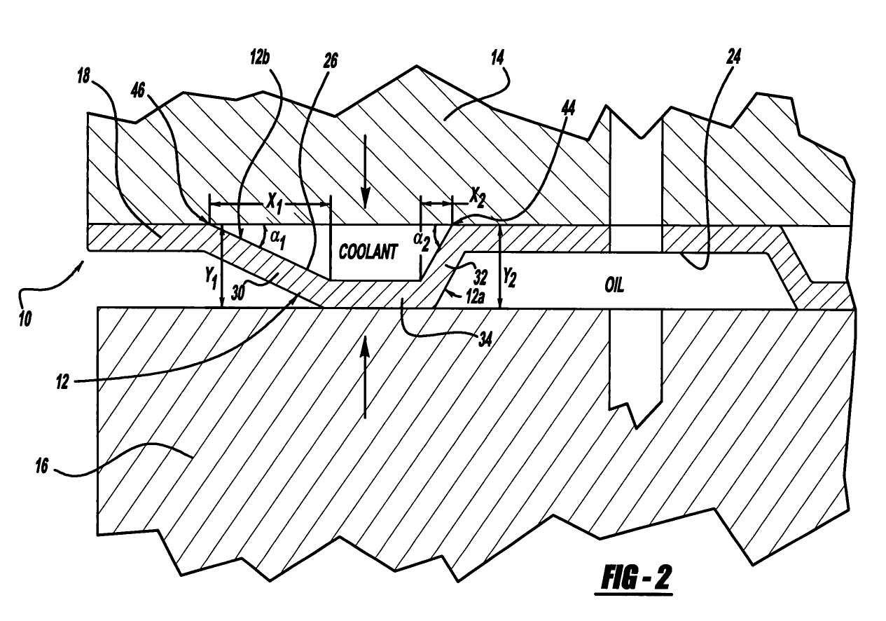

With reference to FIG. 1, a gasket 10 constructed according to the principles of the present invention is shown including an asymmetric bead 12. The gasket 10 is operable to provide a seal between a first component 14 and a second component 16, as illustrated in FIG. 2. Accordingly, the asymmetric bead 12 is formed on the gasket 10 in those portions of the gasket 10 that seal between the first component 14 and the second component 16. It should be appreciated that the present invention is not intended to be limited to the particular arrangement of the asymmetric bead 12 on the exemplary gasket 10 illustrated in FIG. 1.

In the particular example provided, the gasket 10 includes a body 18 which defines a plurality of cylinder head apertures 20. An oil passage 22 is surrounded by an oil cavity 24 which is also provided in the body 18. The oil cavity 24 is circumferentially surrounded by a portion of the asymmetric bead 12, indicated generally by reference numeral 12a. A coolant cavity 26 surrounds the cylinder head apertures 20 and is circumscribed by the bead portion 12b. The coolant cavity 26 is disposed on an opposite side of gasket 10 from the oil cavity 24, as best seen in FIG. 2. The cylinder head apertures 20 are each surrounded by a second bead 28. Asymmetric bead portion 12a is operable to seal the oil cavity 24 from the coolant cavity 26.

The gasket 10 according to one embodiment is adapted to be coupled to and aligned with a cylinder head 14. The coolant cavity 26 will have a first fluid (i.e., coolant) located therein. Simultaneously, the oil cavity 24 will have a second fluid (i.e., oil) located therein. Appropriate passages are provided in the engine block 16 and cylinder head 14 for communicating oil and coolant to the oil cavity 24 and coolant cavity 26, as is known in the art. The asymmetric bead portion 12 seals and separates the first fluid from the second fluid within the gasket 10. However, because the first fluid is a different substance and under different pressures than the second fluid, the first fluid and the second fluid will exert dissimilar forces on the multi-functional bead 12 when under pressure or at an elevated temperature.

Turning now to FIG. 2, a cross-section of the asymmetric bead 12 is provided. The asymmetric bead 12 is formed directly from the body 18. The asymmetric bead 12 includes a first half emboss defined by slope 30, a second half emboss defined by slope 32 and a head portion 34 extending therebetween. As is used in the art, a half “emboss” is typically used to refer to a transition from one planar level of a gasket to another. Accordingly, two associated half embosses define a full emboss in the gasket body that define the bead 12 which is offset from body of the gasket 10. The first slope 30 extends out of the plane of the body 18 to the head portion 34. The head portion 34 extends from the first slope portion 20, parallel to the body 18 and to the second slope 32. The second slope 32 extends from the head portion 34 back to the plane of the body 18.

The first slope 30 is defined by a first length X₁ extending parallel to the plane of the body 18 and a first height Y₁ extending perpendicular to the plane of the body 18. The first slope 30 extends out of the plane of the body 18 at an angle α₁. Similarly, the second slope 32 is defined by a second length X₂ extending parallel to the plane of the body 18 and a second height Y₂ extending perpendicular to the plane of the body 18. The second slope 32 extends out of the plane of the body 18 at an angle α₂. The following conditions apply to the asymmetric bead 12: α₂>α₁; X₁>X₂; and Y₁=Y₂. With these conditions, the asymmetric bead 12 will have an asymmetrical configuration which will provide the asymmetric bead 12 with multiple functions within the gasket 10, as will be described below.

As noted above, the gasket 10 is typically installed between two separate components 14, 16. For illustrative purposes, the first component 14 and the second component 16 are shown in engagement with the gasket 10 and asymmetric bead 12. During assembly, the first component 14 engages the body portion 18 of the gasket 10 in the direction of the arrow. The second component 16 engages the head portion 34 of the bead 12, although it should be understood that the gasket 10 can be configured so that the head portion engages the first component 14. The second half emboss defined by the slope 32 surrounds the oil cavity 24 disposed on a first surface of the body. The first half emboss defined by the first slope 30 encircles the coolant cavity 26 and in the vicinity of the oil cavity, combines to define a full emboss as illustrated in FIG. 2.

The asymmetrical design of the bead 12 of the present invention assures that the bead 12 effectively seals between the first and second components 14, 16. Specifically, as the first component 14 compresses the bead 12, contact point 44 sees a higher stress than contact point 46. This is due to the fact that α₂ is greater than α₁ (i.e., the slope 22 serves as more of a vertical column support). Accordingly, the compressive force exerted by the first component 14 on the second slope 32 is greater than the compressive force exerted on the first slope 30. This assures that the asymmetric bead 12 will seal to the first component 14 to provide increased resistance to the higher pressure oil than to the lower pressure coolant.

As noted above, the asymmetric bead 12 must be able to function in conditions wherein the asymmetric bead 12 separates two separate and different fluids (i.e., oil and coolant). Because the oil is under a different pressure, typically higher than the coolant, the pressure forces exerted on the bead 12 are unbalanced. To balance these pressures, the slope lengths X₁ and X₂ are designed to account for the difference in pressure force. For example, the second slope 32 with a slope length such that X₁>X₂ will present less surface area to the oil, thereby reducing the force on the bead 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gasket comprising:
a body having a first portion disposed within a plane;
a bead formed in the body and including a first half emboss portion positioned at a first angle to the plane of the body, a bead top portion spaced from and positioned generally parallel to the plane of the first portion of the body and connected to the first half emboss portion, and a second half emboss portion positioned at a second angle to the plane of the first portion of the body and connected to the bead top portion;
wherein the first angle is greater than the second angle.

2. The gasket of claim 1, wherein the body is formed from sheet metal.

3. The multi-functional bead of claim 1, wherein the first half emboss portion is connected to the bead top portion opposite the second half emboss portion.

4. A gasket comprising:
a body defining a first cavity having a first fluid therein and a second cavity having a second fluid therein;
a bead extending out from the body and being at least partially between the first and second cavities, the bead defined by a first slope portion connected to a bead top portion which is also connected to a second slope portion, the first slope portion having a length greater than a length of the second slope portion;
wherein the bead is adapted to optimize pressure forces available from a bolt or clamp load between the first fluid in the first cavity and the second fluid in the second cavity.

5. The gasket of claim 4, wherein the body and the bead are formed from sheet metal.
